(19) United States
(12) Patent Application Publication
(10) Pub. No.: US 2024/0375478 A1
(43) Pub. Date: Nov. 14, 2024

(54) FILLING DEVICE FOR AN AIR CONDITIONING SYSTEM

(71) Applicant: AVL DITEST GMBH, Graz (AT)

(72) Inventors: Axel Stupnik, Graz (AT); Dietmar Muchitsch, Graz (AT); Benjamin Ivantsits, Graz (AT)

(21) Appl. No.: 18/692,542

(22) PCT Filed: Sep. 16, 2022
(86) PCT No.: PCT/EP2022/075734

§ 371 Date: Mar. 15, 2024

(30) Foreign Application Priority Data
Sep. 17, 2021 (AT) A50733/2021

(51) Int. Cl. B60H 1/00; F17C 13/02

(52) U.S. Cl. CPC B60H 1/00585; F17C 13/025; F17C 13/026; F17C 2201/0104; F17C 2201/032; F17C 2270/0168

(57) ABSTRACT

The aim of the invention is to enable air conditioning systems of vehicles (F) to be filled with refrigerant (K) in a simpler and more efficient manner. This is achieved by a filling device having a receiving region for receiving a pressure container filled with the refrigerant (K), a valve unit, being connected to an outlet of the pressure container, for controlling the quantity of the refrigerant (K) being supplied to the vehicle (F), and a heating device (9) for heating the pressure container, wherein the heating device has at least one infrared heating unit to heat the pressure container without any contact.

The invention relates to a filling device for carrying out a filling process of an air conditioning system of a vehicle with a refrigerant, wherein a receiving region for receiving a pressure container filled with the refrigerant, a valve unit, being connected to an outlet of the pressure container, for controlling a quantity of refrigerant being supplied to the vehicle, and a heating device for heating the pressure container are provided in the filling device. The invention also relates to a method for carrying out a filling process of an air conditioning system of a vehicle with a refrigerant, wherein the refrigerant is supplied to the vehicle from a pressure container, wherein a supplied quantity of refrigerant is controlled via a valve unit connected to an outlet of the pressure container, and wherein the pressure container is heated to increase a pressure in the pressure container.

When filling an air conditioning system of a vehicle, a refrigerant is usually pumped from a pressure container into the air conditioning system under controlled conditions. In general, for cost reasons, pumps are not used for this purpose; instead, the pressure container is heated to increase the internal pressure. This allows a sufficient pressure difference to be generated, through which the refrigerant flows from the pressure container to the air conditioning system. In known filling devices, the pressure container is heated to a maximum temperature in the range of 55° C., and the pressure is currently limited to approximately 85 bar. In R744 systems, for example, carbon dioxide (CO2) is used as a refrigerant, which is stored in an exchangeable pressure container. Standardized pressure bottles are usually used as pressure containers, which can typically contain an amount of 5 kg to 20 kg or more of the refrigerant CO₂.

Until now, the pressure container has usually been heated using an electric heating mat, which is placed around the pressure container and can be operated using household electricity. A temperature sensor and an additional temperature-dependent safety switch can be integrated in the heating mat. However, the use of a heating mat has some disadvantages. On the one hand, this is a relatively expensive solution, which is contrary to the aim of providing a cost-effective filling device. On the other hand, changing the pressure container is complex and time-consuming, since every time the pressure container is changed, it is necessary to first remove the heating mat from the empty pressure container and then put it back on the new, full pressure container. Furthermore, there is also the risk, when changing the container (e.g. poor thermal connection between the surface of the heating mat and the surface of the pressure container), that improper handling of the heating mat will lead to mistakes, that possibly may have a negative effect on filling accuracy or lead to a loss of heating power. In general, the result is only a moderate heating power, which is also disadvantageous in operation for an efficient and rapid heating of the pressure container, due to the thermal and electrical insulation of the heating mat required for safety reasons.

It is therefore an object of the invention to enable filling processes of vehicle air conditioning systems being carried out more simply and efficiently.

The object is achieved according to the invention by the filling device mentioned at the outset, in that the heating device has at least one infrared heating unit to heat the pressure container without any contact. The object is also achieved by the method mentioned at the outset, in that the pressure container is heated by at least one infrared heating unit without any contact. On the one hand, a more efficient heating of the pressure container by radiant heat is thereby possible, and on the other hand changing containers can be done considerably more easily and quickly. Furthermore, in comparison with heating mats, no grounding of the infrared heating unit and of the pressure container is required.

A control unit for controlling the filling process is preferably provided in the filling device. The filling process can thereby be carried out automatically.

A scale for measuring the weight of the pressure container can be provided in the receiving region optionally. As a result, the weight of the pressure container can be measured during the filling process and the supplied quantity of the refrigerant can be controlled on the basis of the weight measured. As a result, the filling process can be carried out with a prespecified filling quantity.

At least one pressure sensor for detecting a pressure of the refrigerant is advantageously provided in the filling device, and/or at least one temperature sensor is provided for detecting a temperature of the pressure container and/or of the heating device and/or of the refrigerant. Pressure and temperature can thereby be monitored, and the heating device and/or the valve unit can be controlled on the basis of pressure and temperature.

A plurality of infrared heating units, which are preferably arranged distributed around a circumference of the receiving region, can also be provided in the filling device. A larger heating surface can thereby be realized, whereby more efficient heating is possible, in particular in pressure containers of a larger diameter.

It may be advantageous, if a shielding unit is provided in the filling device on a side of at least one infrared heating unit facing away from the receiving region, wherein the shielding unit preferably surrounds the infrared heating unit at least halfway in the circumferential direction. As a result, on the one hand the thermal radiation can be better directed toward the pressure container, and sensitive components of the filling device can also be protected from overheating.

Preferably, at least one infrared heating unit is of elongated shape and arranged in the filling device in such a way that its longitudinal axis runs in parallel to a vertical axis of a pressure container arranged upright in the receiving region. This allows to heat the pressure container over as much of its height as possible.

A user interface connected to the control unit can also be provided at the filling device, via which control parameters of the filling process can be set, in particular a quantity of refrigerant being supplied to the air conditioning system and/or a filling duration. This makes the filling device easy to operate.

The filling device can also be designed as a mobile filling device, wherein wheels can be arranged on an underside of the filling device and/or wherein an energy storage can be provided in the filling device to supply the filling device with energy to carry out at least one filling process. This allows that the filling device can be easily moved between vehicles, e.g. in a workshop, and the filling process can be energy self-sufficient.

It can also be advantageous, if at least one infrared heating unit is arranged being translationally and/or rotationally movable relative to the receiving region. A distance and/or an angle between at least one infrared heating unit and the pressure container can be changed thereby, for example to set a constant distance independently of the pressure container used. This can be advantageous in particular when using pressure containers of different sizes.

The receiving region is preferably designed to receive pressure containers having a cylindrical bottle body with a bottle diameter of 15 cm to 40 cm. The usual standardized pressure cylinders can thus be used in the filling device.

Carbon dioxide is preferably used as refrigerant. The filling device and the method can thus be used for so-called R744 air conditioning systems.

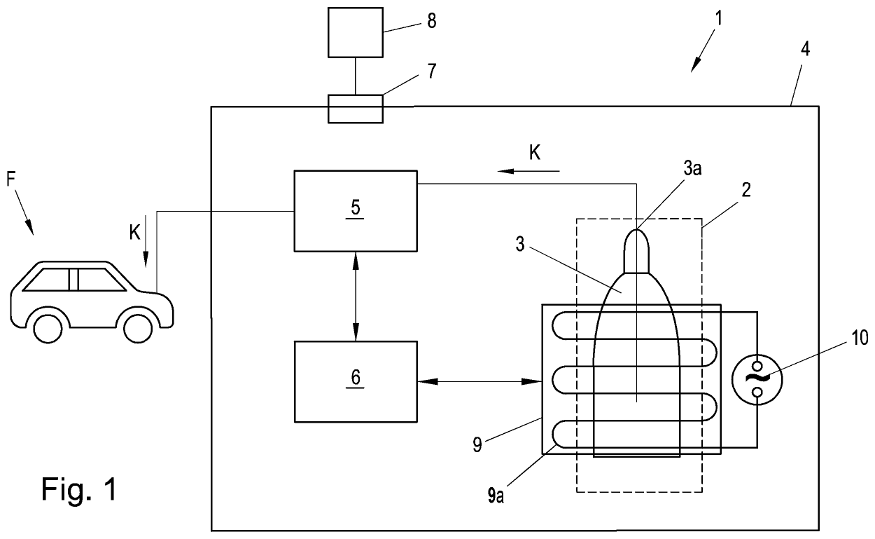

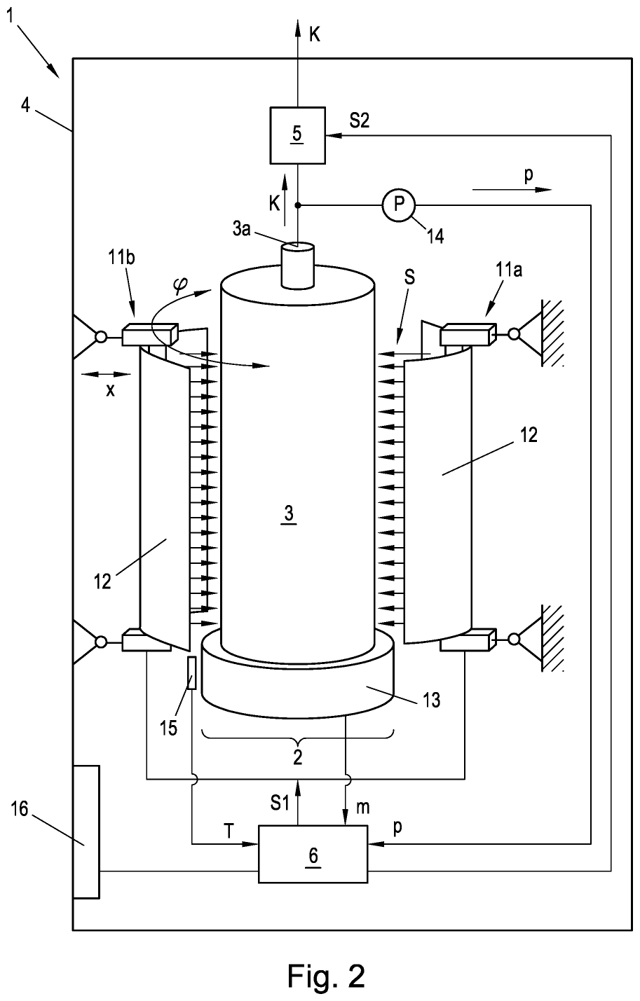

The present invention is described in greater detail below with reference to FIGS. 1 and 2, which show schematic and non-limiting advantageous embodiments of the invention by way of example. In the figures:

FIG. 1 shows the basic structure of a filling device for carrying out a filling process of an air conditioning system of a vehicle, and

FIG. 2 shows a filling device for carrying out a filling process of an air conditioning system of a vehicle according to a preferred embodiment of the invention.

FIG. 1 schematically shows the basic structure of a filling device 1 for carrying out a filling process of an air conditioning system of a vehicle F. The filling device 1 has a receiving region 2 for receiving a pressure container 3 filled with the refrigerant K, for example carbon dioxide (CO2). The receiving region 2 is indicated only schematically in FIG. 1 by the dotted outline of the pressure container 3, and can basically be designed as desired. It is essential only that the receiving region 2 is suitable for receiving a pressure container 3, preferably for receiving pressure containers 3 of different sizes (e.g. height and/or diameter). In a simple embodiment, the receiving region 2 can, for example, comprise only a plate for setting the pressure container 3 down on. However, the receiving region 2 can also be designed such that the pressure container 3 is partially or completely enclosed by a housing 4 of the filling device 1.

A valve unit 5 being connected to an outlet 3a of the pressure container 3 is also provided in the filling device 1. Via the valve unit 5, the quantity of the refrigerant K supplied to the vehicle F from the pressure container 3 can be controlled. In the simplest case, the valve unit 5 can be of a manual design and operated manually by a user, for example. However, the valve unit 5 preferably comprises a controllable actuating element, for example an electrically controllable servo valve, which can be controlled via a control unit 6. The control unit 6 can be a part of the filling device 1, as indicated in FIG. 1. In principle, however, it would also be possible to provide only a suitable interface 7 in the filling device 1, for example on the housing 4, via which interface the valve unit can be connected to an external control unit 8, e.g. a computer.

Furthermore, a heating device 9 for heating the pressure container 3 is provided in the filling device 1. As mentioned at the outset, a heating mat was previously used as the heating device 9, which was placed around the circumference of the pressure container 3 on the surface of the pressure container. In FIG. 1, the heating mat is indicated as an example and can comprise, for example, a number of heating coils 9a, which can be supplied with the necessary energy by a suitable energy source 10, for example a conventional household socket. However, as mentioned at the outset, the use of the heating mat has some disadvantages. According to the invention, the heating device 9 is provided instead, that heating device 9 comprises at least one infrared heating unit 11 to heat the pressure container 3 without any contact. An advantageous embodiment of the filling device 1 according to the invention is explained in more detail below with reference to FIG. 2.

The filling device 1 shown in FIG. 2 again comprises a housing 4, in which a receiving region 2 for a pressure container 3 and a valve unit 5 being connected to the outlet 3a of the pressure container 3 are arranged. In an advantageous manner, a plurality of infrared heating units 11 are provided in the filling device 1, which are preferably arranged distributed around a circumference of the receiving region 2. In the example shown, the heating device 9 has two infrared heating units 11a, 11b, which are arranged essentially opposite each other on the circumference of the receiving region 2. As indicated in FIG. 2, the infrared heating units 11a, 11b generate heat radiation S which is directed onto the surface of the pressure container 3 and heats the pressure container 3. The arrangement of the infrared heating units 11a, 11b opposite each other has the advantage, for example, that the pressure container 3 can be inserted from the side, essentially horizontally, into the receiving region 2. This is particularly advantageous for pressure containers 3 with a relatively large filling capacity of 20 liters or more, as these have a relatively high weight, especially when full. For this purpose, a suitable opening (not shown) can be provided in the housing 4, through which opening the pressure container can be inserted into the receiving region 2. The opening could also be closed by a cover or a door, for example. If additional further infrared heating units 11 are provided on the circumference of the receiving region 2, the pressure container 3 could be inserted into the receiving region 2 from above, for example.

The infrared heating units 11a, 11b can, for example, be in elongated shape and arranged in the filling device 1 in such a way that their longitudinal axes run substantially in parallel to a vertical axis of a pressure container 3 arranged in the receiving region 2, as indicated in FIG. 2. Preferably, the receiving region 2 is designed to receive pressure containers 3 with a cylindrical bottle body with a bottle diameter of 15 cm to 40 cm. This allows the usual standardized pressure cylinders to be used. Particularly when using pressure containers 3 with a relatively small diameter in relation to their height (and thus a relatively high center of gravity), it can also be advantageous if the receiving region 2 is designed in such a way that the pressure container 3 arranged therein is secured against toppling. For example, a suitable catching device (not shown) can be provided that secures the pressure container 3 against unwanted tilting. For example, a preferably pivotable strut in the region between the infrared heating units 11a, 11b, or one or more preferably reclosable belts, would be conceivable. If a scale 13, described in more detail below, is provided in the receiving region 2, then any catching device that may be provided should in any case be designed in such a way that the pressure container 3 is reliably prevented from toppling but the pressure container 3 still stands freely enough on the scale 13 that the most accurate possible measurement of the weight is possible.

A shielding unit 12 is provided on a side of each of the infrared heating units 11a, 11b facing away from the receiving region 2, respectively. On the one hand, the efficiency of the heating can thereby be increased, since the heat radiation S generated by the infrared heating units 11a, 11b can be better directed toward the pressure container 3. This allows a part as large as possible of the surface of the pressure container 3 to be covered by the heat radiation S. It can be advantageous, if the shielding unit 12 surrounds e.g. at least half of the corresponding infrared heating unit 11a, 11b in the circumferential direction. To ensure uniform irradiation of the surface of the pressure container 3, the shielding units 12 can be in parabolic shape, for example, and the infrared heating units 11a, 11b can be arranged at the respective focal point of the parabolic shielding unit 12.

In addition to the directed distribution of the heat radiation S, heat transfer to the other parts of the filling device 1 can also be prevented or at least reduced by the shielding units 12. In this way, sensitive components such as the control unit 6 or electrical, pneumatic, or hydraulic lines can be protected from overheating. The shielding units 12 are preferably made of a sufficiently temperature-resistant material, e.g. a suitable metal and/or plastic. Metal has the advantage that a relatively large portion of the heat radiation S can be reflected and directed toward the pressure container 3. Plastic, for its part, has the advantage of lower thermal conductivity, which results in less heat radiation in the direction of the other components of the filling device 1.

It would therefore also be conceivable, for example, for the shielding units 12 to be made of a suitable plastic and for only the inside facing the receiving region 2 is coated with a suitable metal to reflect the heat radiation S as well as possible. Of course, the type and design of the shielding unit 12 depends on the number and the design of the infrared heating units 11. For particularly good thermal insulation, it would also be conceivable for a thermally insulating material to be additionally arranged around the receiving region 2 and the infrared heating units 11a, 11b. For example, the inside of the housing 4 could be lined with a suitable insulating material. It would likewise be conceivable for any lines (electrical, hydraulic, pneumatic) present to be protected against excessive heating by providing an insulation.

According to an advantageous embodiment, the infrared heating units 11a, 11b can be arranged in the filling device 1 so that they can move translationally or rotationally relative to the receiving region 2. For example, in this way a position X and/or an angle q of the corresponding infrared heating unit 11a, 11b relative to the receiving region 2 or the pressure container 3 can be adjusted. A height adjustment would of course also be conceivable. This adjustability is advantageous, for example, when using pressure containers 3 of different diameters, to be able to set a distance between the infrared heating units 11a, 11b and the pressure container 3. Of course, the shielding units 12 could also be arranged to be movable. For example, the shielding units 12 could be fixedly arranged on the infrared heating units 11a, 11b and movable together with the infrared heating units 11a, 11b. However, the shielding units 12 could also be fastened to the housing 4 and arranged to be movable relative to the infrared heating units 11a, 11b.

The embodiment shown, with two infrared heating units 11a, 11b, is of course only an example, and within the scope of the invention it would of course also be possible to provide more than or fewer than two infrared heating units 11. For example, in the case of pressure containers 3 of a relatively large diameter, it could be advantageous for more than two infrared heating units 11a, 11b to be provided distributed around the circumference of the receiving region 2, e.g. three to eight infrared heating units 11.

For a particularly efficient heating of the pressure container 3, it can also be advantageous, if a surface of the pressure container 3 is coated, for example, with a suitable lacquer, for example radiator paint. The surface should have the highest possible absorption coefficient in the infrared range. The absorption coefficient also depends on the wavelength of the infrared radiation and is preferably 0.9 to 1, preferably 0.95 to 1, in the range within which the maximum of the infrared radiation lies. This can at least partially overcome the disadvantage that metals only absorb IR radiation in the near-infrared range (NIR), in the range of approx. 800-1400 nm, and primarily reflect longer wavelengths. Alternatively or additionally, a lamp of the infrared heating units 11 could itself also be adapted, for example by using quartz-tungsten lamps that emit in the NIR range instead of the more commonly used ceramic lamps. Furthermore, it would be conceivable for one or more suitable LED lamps to be used for the NIR range in addition to the at least one infrared heating unit 11.

In the filling device 1, there is additionally provided a control unit 6 for controlling the filling device 1, via which unit the filling process can be controlled. For this purpose, the control unit 6 is connected at least to the valve unit 5 and is designed to control the valve unit 5 in order to control a refrigerant quantity of the refrigerant K that is discharged from the pressure container 3 and can be supplied to the vehicle F. According to an advantageous embodiment, the control unit 6 is also connected to the heating device 9, in particular to the infrared heating units 11a, 11b, so that the heating device 9 can be activated or deactivated via the control unit 6 and, for example, the heat output of the infrared heating units 11a, 11b can also be controlled, preferably in variable fashion.

A scale 13 for measuring the weight of the pressure container 3 is preferably also provided in the receiving region 2 of the filling device 1, which scale communicates with the control unit 6 in a suitable manner. As a result, during a filling process a prespecified filling quantity can be indicated to the air conditioning system of the vehicle F, in that the control unit 6 controls the valve unit 5 depending on a measured value m of the scale. For this purpose, for example the detected weight m of the pressure container 3 can be used as the initial weight m0 before the start of the filling process and a desired filling quantity could be specified to the control unit 6 in the form of a filling weight mF. The control unit 6 can then keep the valve unit 5 open until the detected weight m of the pressure container 3 corresponds to the initial weight m0 minus the filling weight mF. Alternatively or in addition, to the scale 13, another form of measuring the filling quantity, in particular the filling weight, could also take place. For example, a suitable flow measuring device (not shown) could be provided in the filling device 1, for example in the region of the valve unit 5, which measuring device detects a flow rate (volume flow or mass flow). The control unit 6 could control the valve unit 5 on the basis of the detected flow rate in order to set the supplied filling quantity.

Furthermore, at least one pressure sensor 14 for detecting a pressure p of the refrigerant K and/or at least one temperature sensor 15 for detecting a temperature T of the refrigerant K and/or of the pressure container 3 and/or of the heating device 9 can be provided in the filling device 1. The pressure sensor 14 can be arranged between the outlet 3a of the pressure container 3 and the valve unit 5, for example, and can communicate with the control unit 6 in a suitable manner. The temperature sensor 15 can be designed as an infrared sensor, for example, to measure the surface temperature of the pressure container 3, and can also communicate with the control unit 6 in a suitable manner. Of course, a plurality of temperature sensors 15 or pressure sensors 14 can also be provided in each case, and other types of sensors would also be conceivable.

The control unit 6 can use the detected sensor values p, T to control or regulate the heating device 9 and possibly also the valve unit 5. For this purpose, a suitable controller, for example a PI or PID controller, can also be integrated in the control unit 6. For example, the controller can determine a manipulated variable S1 for controlling the heating device 9, and, if necessary, a manipulated variable S2 for controlling the valve unit 5, from a prespecified target variable, e.g. a target temperature or a target pressure, and from the detected sensor values p, T. The control unit 6 can control the heating device 9 and, if necessary, the valve unit 5 with the manipulated variables S1, S2 in order to adjust the specified target values. The heating device 9 can also be controlled cyclically (on/off), for example. For example, a maximum temperature can also be prespecified and the control unit 6 can control the heating device 9 accordingly so that the maximum temperature is not exceeded.

Advantageously, a user interface 16 connected to the control unit 6 can also be provided in the filling device 1, via which interface control parameters of the filling process can be set. Via the user interface 16, a user can for example set a specific filling quantity or filling duration which is then automatically supplied to the vehicle F. The user interface 16 can also have an operating unit for this purpose, which can include operating buttons, sliders, or a touchscreen, for example. However, the user interface 16 could also be designed without an operating unit and, for example, could be designed only for connection to an external computer. The filling process could then be controlled via the external computer.

A filling device 1 is generally used in workshops to fill a plurality of vehicles F which may be located at different locations. It can therefore be advantageous if the filling device 1 is designed as a mobile filling device. For this purpose, wheels can be arranged on the underside of the filling device 1 in order to be able to move the filling device 1 manually. For a self-sufficient operation of the filling device 1 as regards energy, a suitable energy storage device not shown, for example an electrical battery, could also be provided in the filling device 1. In this way, one or more filling processes could be carried out without an external power supply.

1. A filling device for carrying out a filling process an air conditioning system of a vehicle with a refrigerant, wherein in the filling device there are provided a receiving region for receiving a pressure container filled with a refrigerant, a valve unit being connected to an outlet of the pressure container for controlling a quantity of the refrigerant being supplied to the vehicle, and a heating device for heating the pressure container, wherein the heating device has at least one infrared heating unit to heat the pressure container without any contact.

2. The filling device according to claim 1, wherein a control unit for controlling the filling process is provided in the filling device.

3. The filling device according to claim 1, wherein a scale for measuring a weight of the pressure container is provided in the receiving region.

4. The filling device according to claim 1, wherein at least one pressure sensor for detecting a pressure of the refrigerant is provided in the filling device.

5. The filling device according to claim 1, wherein a plurality of infrared heating units are provided in the filling device, which are arranged distributed around a circumference of the receiving region.

6. The filling device according to claim 1, wherein a shielding unit is provided in the filling device on a side of at least one infrared heating unit facing away from the receiving region, the shielding unit surrounding the infrared heating unit at least halfway in the circumferential direction.

7. The filling device according to claim 1, wherein at least one infrared heating unit is of elongated shape and is arranged in the filling device in such a way that its longitudinal axis runs in parallel to a vertical axis of a pressure container arranged upright in the receiving region.

8. The filling device according to claim 2, wherein a user interface connected to the control unit is provided on the filling device, via which user interface control parameters of the filling process can be set, wherein the control parameters are selected from the group consisting of a quantity of the refrigerant being supplied to the air conditioning system and a filling duration.

9. The filling device according to claim 1, wherein characterized in that the filling device is designed as a mobile filling device, wherein wheels are arranged on an underside of the filling device and/or wherein an energy storage is provided in the filling device to supply energy to the filling device for carrying out at least one filling process.

10. The filling device according to claim 1, wherein at least one infrared heating unit is moveable relative to the receiving region, in a manner selected from the group consisting of translationally moveable relative to the receiving region and rotationally movable relative to the receiving region.

11. The filling device according to claim 1, wherein the receiving region is designed to receive pressure containers having a cylindrical bottle body with a bottle diameter of 15 cm to 40 cm.

12. A method for carrying out a filling process of an air conditioning system of a vehicle with a, wherein the refrigerant is supplied to the vehicle from a pressure, wherein a supplied quantity of the refrigerant is controlled via a valve unit connected to an outlet of the pressure container, and wherein the pressure container is heated to increase a pressure in the pressure container, wherein the pressure container is heated by at least one infrared heating unit without any contact.

13. The method according to claim 12, wherein carbon dioxide is used as the refrigerant.

14. The method according to claim 13, wherein the filling process is controlled by a control unit.

15. The method according to claim 12, wherein a weight of the pressure container is measured during the filling process and in that the supplied quantity of the refrigerant is controlled on the basis of the measured weight.

16. The method according to claim 12, wherein a measurement is detected, the measurement selected from the group consisting of a pressure of the refrigerant, a temperature in the region of the pressure container, a temperature of the at least one infrared heating unit, and a temperature of the refrigerant, and controlling a unit selected from the group consisting of in that the infrared heating unit and the valve unit, based on a respective one of the detected pressure and the detected temperature.

17. The method according to claim 12, wherein the pressure container is heated by a plurality of infrared heating units, which are distributed around a circumference of the pressure container.

18. The method according to claim 12, wherein a side of at least one infrared heating unit facing away from the pressure container is shielded by a shielding unit, wherein the shielding unit surrounds the infrared heating unit at least halfway in the circumferential direction.

19. The method according to claim 14, wherein at least one control parameter of the filling process is set via a user interface connected to the control unit, wherein the control parameter is selected from the group consisting of the supplied quantity of the refrigerant and and/or a filling duration of the filling process.

20. The method according to claim 12, wherein an orientation between at least one infrared heating unit and the pressure container are changed, wherein the orientation is selected from the group consisting of a distance and an angle.

21. The filling device according to claim 1, wherein at least one temperature sensor for detecting a temperature of a component selected from the group consisting of the pressure container, the heating device, and the refrigerant is provided in the filling device.

22. The filling device according to claim 1, wherein an energy storage is provided in the filling device to supply energy to the filling device for carrying out at least one filling process.
